(19) United States
(12) Patent Application Publication
(10) Pub. No.: US 2005/0094523 A1
(43) Pub. Date: May 5, 2005

(54) Method and apparatus for detecting run-out in optical disk drive

(75) Inventor: Jan-Tang Wu, Taipei (TW)

Correspondence Address: BRUCE H. TROXELL, SUITE 1404, 5205 LEESBURG PIKE, FALLS CHURCH, VA, 22041, US

(73) Assignee: Ali Corporation

(21) Appl. No.: 10/879,167

(22) Filed: Jun. 30, 2004

(30) Foreign Application Priority Data
Oct. 31, 2003 (TW) 92130374

(51) Int. Cl. G11B 7/00; G11B 5/58

(52) U.S. Cl. 369/53.14; 369/44.32

(57) ABSTRACT

The present invention discloses a method and apparatus for detecting a run-out disc in an optical disk drive, wherein the amplitude level of a center error signal or a frequency of half-track signal per unit time is used as the basis for the detection. Unlike the prior art of using the tracking error signal as basis for the detection, it is easier for the invention to detect the run-out, and the half-track signal is not troubled by the noises on the trigger source which is suffered by tracking error signal, and thus preventing a misjudgment of run-out.

### 1. FIELD OF THE INVENTION

The present invention relates to a method and apparatus for detecting a run-out disc in an optical disk drive, and more particularly, to a method and apparatus for detecting a run-out disc in an optical disk drive by using an amplitude level of a center error signal or a half-track signal frequency per unit time as the bases of evaluation.

### 2. BACKGREVOLUTION OF THE INVENTION

In general, the carrier of an optical disk drive for loading an optical disk or the tracks of an optical disk is not exactly circular. Therefore, the optical disk cannot be mounted precisely onto the center of an optical disk. As a result, an optical pickup head of the optical disk drive runs out of a track very easily when the pickup head reads/writes data from/in the optical disk, and the pickup head of the optical disk drive cannot read/write data from/into the correct track of the optical disk.

While detecting a run-out, it is common that the optical disk drive will lower the drive speed from a high speed (such as 52×) to a middle speed (such as 32×) to eliminate the run-outs and enable the pickup head to read/write data from/into the correct track.

The conventional optical disk drive uses a tracking error signal from the optical pickup head thereof as the base for detecting a run-out disc in the optical disk drive. Please refer to FIG. 1A and FIG. 1B, which are the waveforms of a conventional optical disk drive that uses a tracking error signal to detect a run-out disc in the optical disk drive. As seen in FIG. 1A, a tracking error signal from the optical pickup head is being used for detecting run-outs while the pickup head is not running out, the maximum amplitude of the tracking error signal, which is the signal shown in the Channel C, is 0.73 volt and is the result of amplifying the tracking error signal, which is the signal shown in the Channel A, by a band-pass filter.

On the other hand, if a run-out is happening, the maximum amplitude of the tracking error signal, which is the signal shown in the Channel C of FIG. 1B, is 0.82 volt and is the result of amplifying the tracking error signal, which is the signal shown in the Channel A of FIG. 1B, by a band-pass filter.

In this regard, while using a tracking error signal to detect a run-out disc in an optical disk drive, the tracking error signal with noises (particularly when such disk is read at a high speed) amplified by a band-pass filter does not show a significant difference on the amplification waveform. Such method of detecting run-out disc in an optical disk drive by the tracking error signal usually causes misjudgments and cannot actually detect the run-out. If an optical disk drive cannot detect whether a run-out is happening, the optical disk drive cannot reduce the reading speed in time for enabling the pickup head to read/write data from/in the correct track, and consequently, the pickup head will repetitively try to read/write data from/into the correct track at a high speed, which causes a low performance on accessing data, or even has a risk of crashing the system.

In view of the foregoing shortcomings, the present invention discloses a method and apparatus for detecting run-outs in an optical disk drive to optimize the system performance of the optical disk drive and the correct access of the loaded optical disk.

### SUMMARY OF THE INVENTION

The primary object of the present invention is to provide a method and apparatus for detecting a run-out disc in an optical disk drive, which uses a center error signal for orientating the pickup head as run-out signal for detecting a run-out disc in the optical disk drive.

In a preferred embodiment of the invention, the foregoing method further comprises the step of:
making an evaluation to detect a run-out disc in an optical disk drive according to the amplitude level of the center error signal; and
processing the center error signal with a bad-pass filter before the center error signal is used as a base for determining whether the loaded disk in the optical disk drive is run-out, wherein the band-pass filter is a band-pass filter with two or more levels.

The other object of the present invention is to provide a method for detecting a run-out disc in an optical disk drive, featuring that the number of tracks accessed by the pickup head of the optical disk drive per unit time is used for detecting a run-out disc in the optical disk drive.

In a preferred embodiment of the invention, if the number of tracks of an optical disk accessed per unit time is larger than a specified value, the optical disk is determined as run-out; if the number of tracks of an optical disk accessed per unit time is smaller than or equal to the specified value, the optical disk is determined as not run-out. A plurality of polar points disposed on a motor of the optical disk drive is used to calculate the time for the motor to rotate an integral number of revolutions, which is used as the abovementioned unit time, and the tracking error signal and radio frequency ripple signal of the optical disk drive is used for the mirroring and producing a half-track signal in order to evaluate the track number of the pickup head on the optical disk.

Yet, another object of the present invention is to provide an apparatus for detecting a run-out disc in an optical disk drive, comprising a preamplifier, an analog/digital converter, and a digital signal processor; wherein the preamplifier mainly receives a signal outputted by a pickup head to produce a center error signal, a tracking error signal, and a radio frequency ripple signal, and the analog/digital converter mainly coverts the center error signal, tracking error signal, and radio frequency ripple signal from analog signals into digital signals, and the digital signal processor selectively receives the digitized center error signal, tracking error signal and radio frequency ripple signal as the basis for run-out detection.

Therefore, if the digital signal processor receives a center error signal, then the foregoing method for detecting a run-out disc in an optical disk drive by the center error signal is adopted. If the digital signal processor receives the tracking error signal and the radio frequency ripple signal, then the method for detecting a run-out disc in an optical disk drive by the track number of the optical disk scanned by the pickup head per unit time.

In summation of the description above, the present invention discloses a method and an apparatus of detecting a run-out disc in an optical disk drive, which can effectively detect the run-out of an optical disk in an optical disk drive, so that the optical disk drive can read/write data correctly from/in a loaded optical disk with an optimal speed.

### BRIEF DESCRIPTION OF THE DRAWINGS

FIGS. 1A and 1B are the waveforms of a conventional optical disk drive that uses a tracking error signal to detect a run-out disc in the optical disk drive.

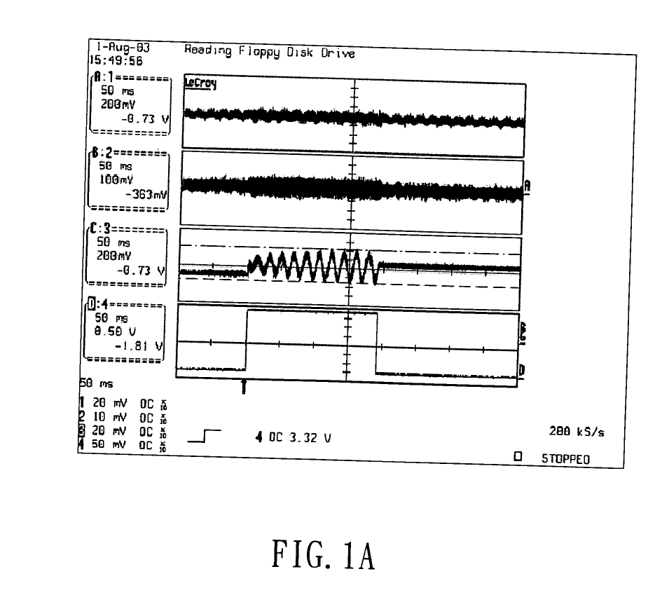

FIG. 2 is a schematic diagram of a pickup head and a carrier thereof disposed in an optical disk drive of the present invention.

FIG. 3 is a schematic diagram showing the center error signal before and after the frequency conversion.

FIG. 4A and FIG. 4B are the waveforms of an optical disk drive that uses a center error signal to detect a run-out disc in the optical disk drive according to the present invention.

FIG. 5 is an illustrative view of a motor in the optical disk drive.

FIG. 6 is a schematic diagram depicting a half-track signal produced by the tracking error signal and the radio frequency ripple signal.

FIG. 7 is a signal chart of detecting a run-out disc in the optical disk drive using track number according to the present invention.

FIG. 8 is a diagram showing an apparatus for detecting a run-out disc in the optical disk drive according to a preferred embodiment of the present invention.

FIG. 9 is a flow chart of the internal operation of the digital signal processor 830 as depicted in FIG. 8.

FIG. 10 is the timing chart of detecting a run-out disc in the optical disk drive by using a center error signal according to the present invention.

### DESCRIPTION OF THE PREFERRED EMBODIMENT

The conventional optical disk drive uses a tracking error signal returned by the pickup head as a detecting signal for detecting a run-out optical disk loaded in the optical disk drive. Thus, the amplitude level difference between the tracking error signal of a run-out disc and of a normal running disc is not significantly large such that the optical disk drive cannot have access to such optical disk. The present invention considers using other signal to replace such tracking error signal in hope of other signal can show a significant amplitude level difference when there is a run-out disc.

To make it easier for our examiner to understand the objective of the invention, its structure, innovative features, and performance, we use a preferred embodiment together with the attached drawings for the detailed description of the invention.

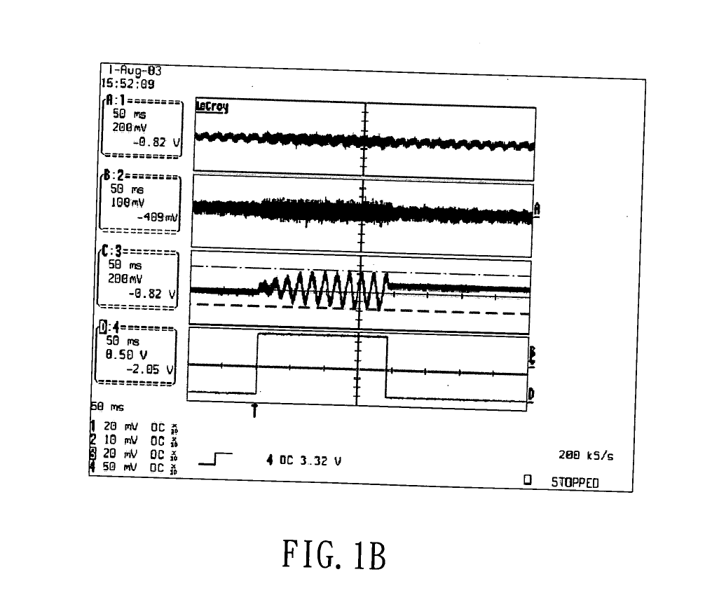

Please refer to FIG. 2 for an illustrative view of a pickup head and a carrier in an optical disk drive. In FIG. 2, those skilled in the art can understand that if there is a run-out disc 205 in an optical disk drive, the pickup head 210 in the optical disk drive and the carrier 220 for loading the pickup head 210 will shift in the run-out direction. However, the optical disk drive will control the relative position of the pickup head 210 and the carrier 220 according to a center error signal in order to orient the pickup head 210 to the center of the carrier 220.

Since the center error signal is corresponding to the relative position of the the pickup head 210 and the carrier 220 as the run-out of the disc 205, therefore such center error signal can be used as a signal responding to the run-out of the optical disk 205, and more particularly, a frequency conversion signal is loaded along with the run-out of the optical disk 205 for enabling the center error signal to have a significant change in the amplitude level.

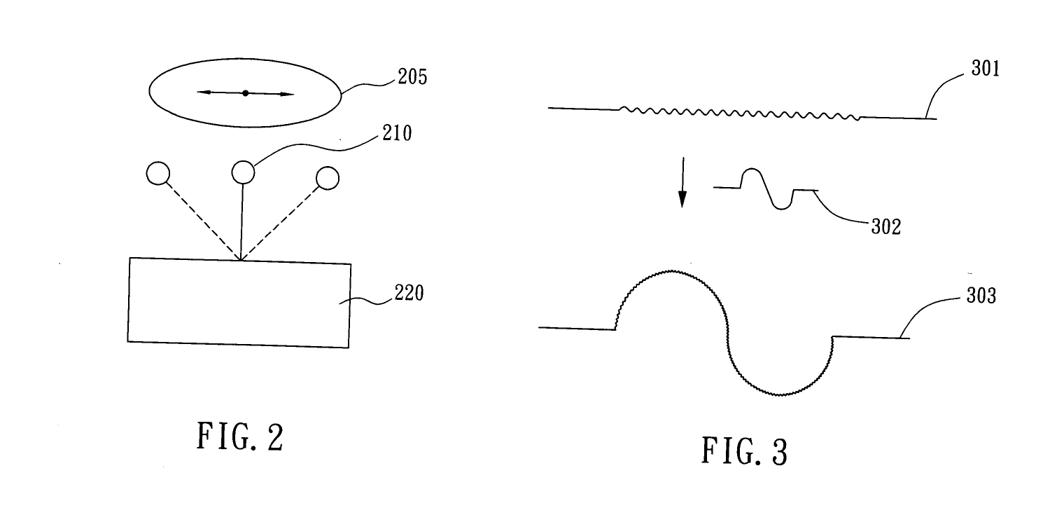

Please refer to FIG. 3, which is a schematic diagram showing the center error signal before and after the frequency conversion. In FIG. 3, a sine wave conversion signal 302 having the same frequency as the run-out frequency of the optical disk will be loaded to produce a center error signal 303 loaded with the frequency conversion signal 302.

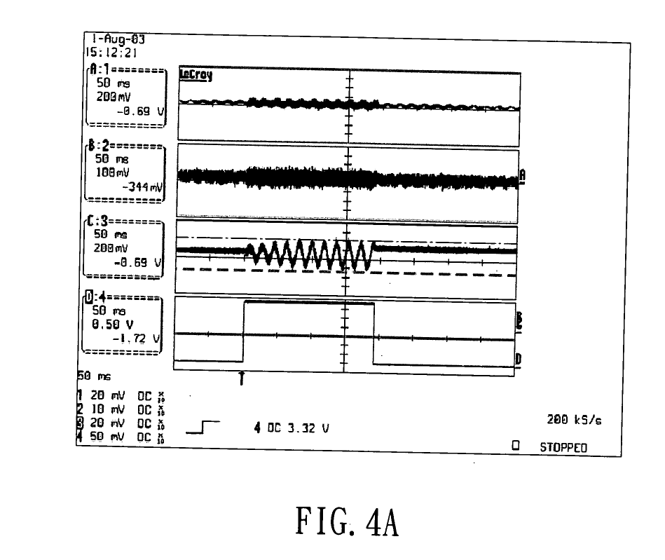

Therefore, By using the center error signal as the detection signal to detect a run-out disc in an optical disk drive, the amplitude level should have a significantly difference. Please refer to FIG. 4A and FIG. 4B, which are the waveforms of an optical disk drive that uses a center error signal to detect a run-out disc in the optical disk drive according to the present invention. As seen in FIG. 4A, a center error signal is being used for detecting run-outs while the optical disk is not run-out, the maximum amplitude of the center error signal, which is the signal shown in the Channel C, is 0.69 volt and is the result of amplifying the center error signal, which is the signal shown in the Channel A, by a band-pass filter with two or more levels.

On the other hand, if a run-out is happening, the maximum amplitude of the center error signal, which is the signal shown in the Channel C of FIG. 4B, is 1.12 volt and is the result of amplifying the center error signal, which is the signal shown in the Channel A of FIG. 4B, by a band-pass filter.

Compared with the prior art, the amplitude levels difference is 0.09 volt while using the tracking error signal for detecting a run-out disc in an optical disk drive, and the amplitude levels difference is 0.43 volt while using the center error signal for detecting a run-out disc in an optical disk drive which is obviously a larger difference.

Further, the present invention discloses a method for detecting a run-out disc in an optical disk drive using the track number of the pickup head of the optical disk drive during the time for an optical disk to rotate an integer number of revolutions. The reasoning is that, within the time of integer revolutions, the tracking number of a run-out disc will be larger then that of a normal running disc.

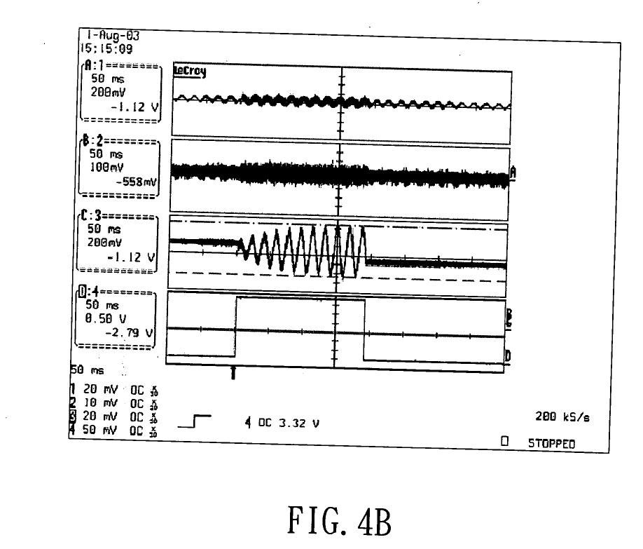

In a preferred embodiment of the invention, the polar points on the motor of an optical disk drive are used to calculate the time for the optical disk to rotate an integer number of revolutions. Further, the tracking error signal and the radio frequency ripple pulse (RFRP) signal is used for producing a half-track signal to calculate the track number. Please refer to FIG. 5 for an illustrative view of the motor in an optical disk drive. In FIG. 5, the motor 500 of an optical disk drive used for rotating an optical disk has a plurality of polar points 510, which can be 6 or 18 polar points, and if the motor 500 rotates an integer number of revolutions, then the optical disk also rotates an integer number of revolutions and as well as the six polar points on the motor 500. With the six polar points 510 on the motor 500, the time for the optical disk to rotate an integer number of revolutions can be calculated.

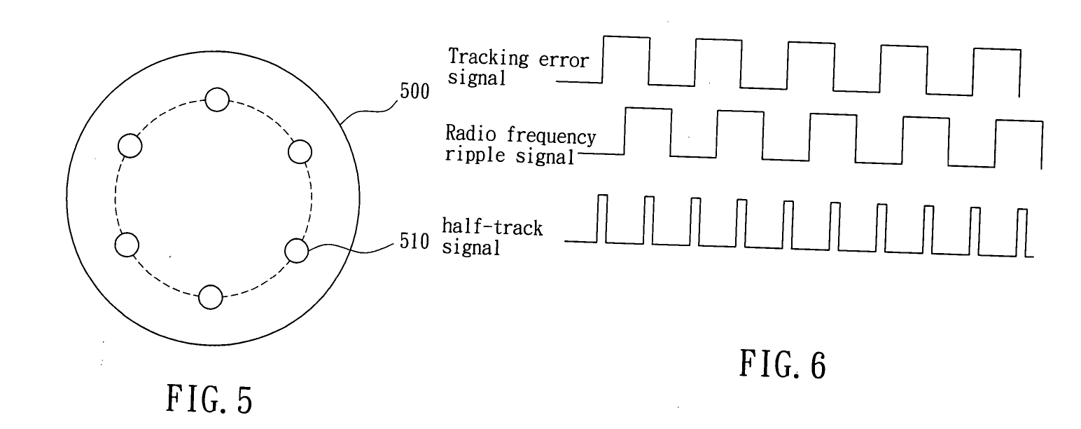

Please refer to FIG. 6, which is a schematic diagram depicting a half-track signal produced by the tracking error signal and the radio frequency ripple signal. After the tracking error signal 610 generated according to the shape of the tracks on an optical disk and a radio frequency ripple pulse signal 620 both are triggered by a triggering source with respect to each other and are mirrored, a half-cycle signal 630 corresponding to the tracks of the mirrored optical disk is generated. However, the track cycle of such half-cycle signal 630 is half of the track cycle on the optical disk. Since such half-cycle signal 630 is generated according to the triggering sources of the tracking error signal 610 and the radio frequency ripple pulse signal 620, therefore the triggering source of such half-track signal 630 does not have the noises produced by the triggering sources of the tracking error signal 610 and the radio frequency ripple pulse signal 620.

The track number scanned by the pickup head on a run-out optical disk must be larger than that scanned by the pickup head on a normal running optical disk during the optical disk rotates an integer number of revolutions, wherein, by obtaining the time for the optical disk to rotate an integer number of revolutions from the six polar points 510 on the motor 500 as shown in FIG. 5 along with the half-track signal 630 mirroring the track of the optical disk, the track number can be accurately calculate.

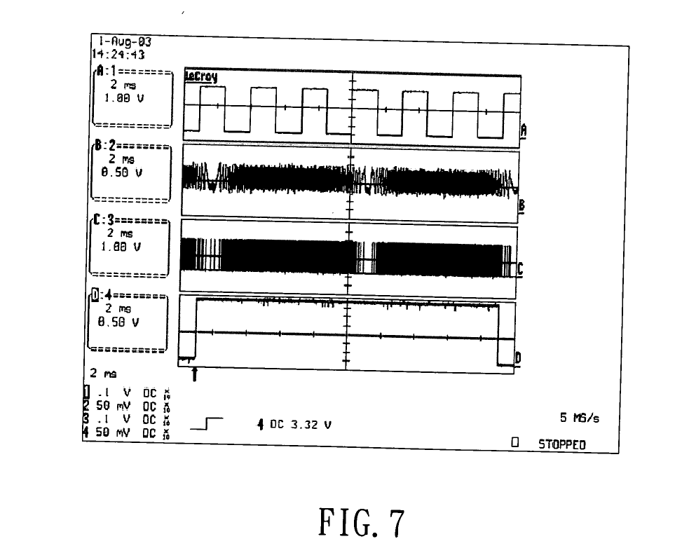

Please refer to FIG. 7 for a method for detecting a run-out disc in an optical disk drive using the tracking number of the pickup head. As seen in FIG. 7, if the number of rotation of an optical disk at the frequency channel A is an integer, the time duration between the triggering sources of signals at the frequency channel D is used as unit time. The half-track signal corresponding to the frequency channel C per unit time is the signal-produced after the tracking error signal at frequency channel B and the radio frequency ripple pulse signal are mirrored, and the number of oscillations is obviously larger than the number of oscillations of a run-out optical disk.

Therefore, if the center error signal or the half-track signal per unit time is used as the detecting signal of detecting a run-out disc, such method can effectively replace the prior-art method of using a tracking error signal as the detecting signal of detecting a run-out disc.

The foregoing method uses a digital signal processor to selectively receive the center error signal or the half-track signal so as to achieve the object of detecting a run-out disc in an optical disk drive.

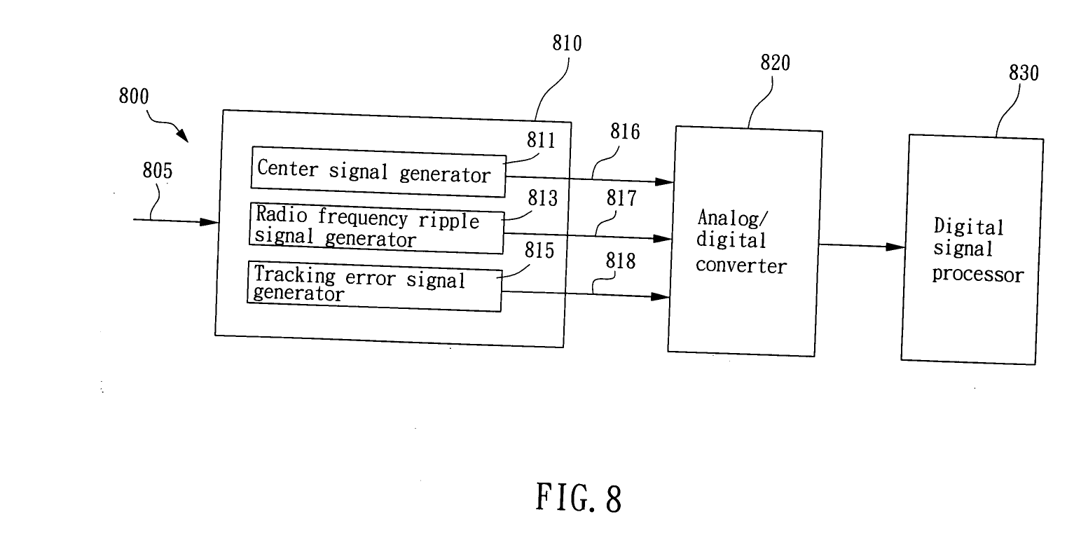

Please refer to FIG. 8, which is a diagram showing an apparatus for detecting a run-out disc in the optical disk drive according to a preferred embodiment of the present invention. In FIG. 8, an apparatus 800 in the optical disk drive for detecting a run-out disc in an optical disk comprises a pre-amplifier 810, an analog/digital converter 820, and a digital signal processor 830; wherein the pre-amplifier 810 receives a signal 805 outputted from the pickup head of the optical disk drive for producing an analog center error signal 816, an analog radio frequency ripple pulse signal 817, and an analog tracking error signal 818 respectively by using the internal center signal generator 811, radio frequency ripple signal generator 813, and a tracking error signal generator 815, and the analog center signal 816, analog radio frequency ripple signal 817, and analog tracking error signal 818 are converted into digital signals by the analog/digital converter 820, in addition, the digital signal processor 830 will selectively receive the center signal 816, radio frequency ripple signal 817, and tracking error signal 818 as the signal for detecting a run-out disc in the optical disk.

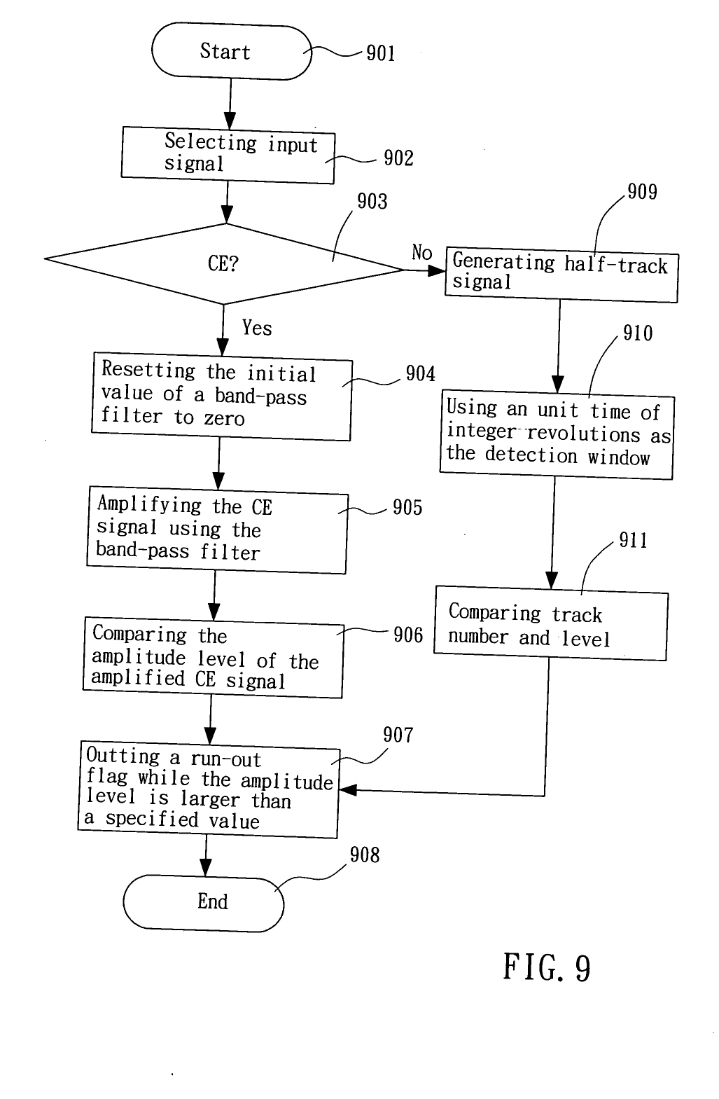

Please refer to FIG. 9 for the flow chart of the internal operation of the digital signal processor 830. At step 901, the optical disk drive starts detecting whether or not the loaded optical disk is run-out. Flow proceeds from step 901 to step 902. At step 902, the digital signal processor will receive a signal selected from the group consisting of a center error signal, a radio frequency ripple signal, and a tracking error signal for detecting a run-out disc in the optical disk drive. Flow them proceeds to decision step 903.

At decision step 903, an evaluation is being made to determine whether the received signal is a center error signal. If so, flow proceeds from step 903 to step 904; otherwise, flow proceeds to step 909. At step 904, the digital signal processor will reset the initial values of an internal band-pass filter to zero for preparing the band-passing filter to amplify the center error signal. Then, flow proceeds from step 904 to Step 905. At step 905, the band-pass filter is used for amplifying the center error signal. Flow proceeds from step 905 to step 906.

At step 906, the digital signal processor compares the amplitude level of the amplified center error signal with a specified value. Flow then proceeds from step 906 to step 907. At step 907, if the amplitude level of the center error signal is larger than a standard value of a run-out disc, the digital signal processor will output a run-out flag signal; otherwise, the digital signal processor will not output the run-out flag signal. Flow the proceeds from step 904 to step 908 where the detection ends.

At step 909 where the received signal is not a center error signal but are a radio frequency ripple signal and a tracking error signal, the digital signal processor will trigger the radio frequency ripple signal and the tracking error signal to produce a half-track signal that represents the number of tracks scanned by a pickup head on an optical disk. Flow proceeds from step 909 to step 910. At step 910, the digital signal processor will determine the time of rotating an integral number of revolutions of an optical disk according to the polar points on the motor of the optical disk drive, and the time for rotating the optical disk in an integral number of revolutions. The time for such optical disk to rotate an integral number of revolutions is used as the unit time for the half-track signal as shown in Step 910. Flow proceeds from step 910 to step 911.

At step 911, the digital signal processor uses the half-track signal per unit time to determine the number of tracks scanned by the pickup head per unit time. Flow then proceeds to step 907 for outputting a run-out flag while the track number is larger than a specified value.

If the number of tracks scanned by the pickup head per unit time is larger than a standard value for the tracking error of the optical disk drive, then a run-out flag signal will be outputted; on the other hand, the run-out flag signal will not be outputted.

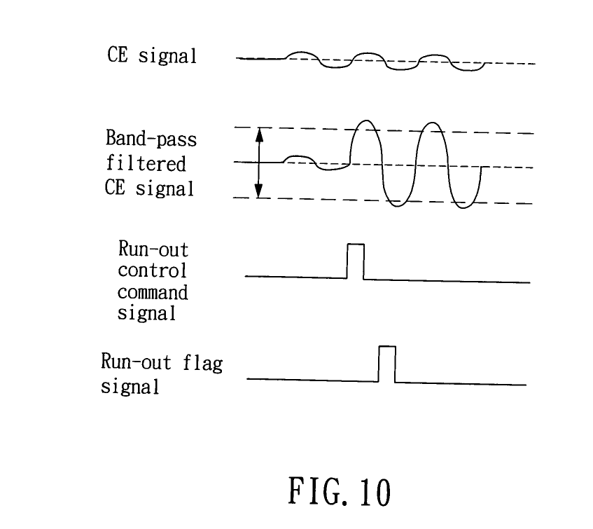

Please refer to FIG. 10 for the signal timing chart as the procedure jumps from Step 904 to Step 907. FIG. 10 shows the timing chart of using the center error signal to detect the tracking error of an optical disk. In FIG. 10, the digital signal processor amplifies the center error signal by a band-pass filter. If the amplification level exceeds a standard value, then a run-out control command signal and a run-out flag signal of will be produced successively. Such command signal and flag signal are used to control the speed of accessing the optical disk.

The method and the apparatus for detecting the tracking error of an optical disk drive have the following advantages:
1. Since the center error signal carries a frequency conversion signal when the optical disk is run-out, the amplitude level will be more significant than that of the optical disk running normal. Therefore, if the center error signal is used as a detecting signal for detecting a run-out disc, the variation of amplitude level is more significant that the detection is easier comparing to that of the prior art.
2. While using the track number for detecting a run-out disc in an optical disk drive, the polar points of the motor is used for obtaining unit time of integer revolutions and the half-track signal formed by the tracking error signal and the radio frequency ripple signal is used for representing the track number. Therefore, using the half-track signal per unit time not only can detect the run-out disc effectively, but also such half-track signal is unlike the prior-art tracking error signal that have noises on the triggering source thereof and affect the detection of run-out.

In summation of the description above, the present invention discloses a method and apparatus for detecting a run-out disc in an optical disk drive. The amplitude level of the center error signal or the track number represented by the half-track signal per unit time is used for the detection. Compared with the prior art that uses the tracking error signal for the detection, the present invention is more effective to detect the run-out, and the half-track signal will not have a triggering source with noises. Therefore, the present invention definitely provides a better and more accurate mechanism for detecting a run-out disc in an optical disk drive.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. A method for detecting a run-out disc in an optical disk drive, comprising:
applying a center error signal used for orientating a pickup head of the optical disk drive as a run-out signal for detecting the run-out disc in the optical disk drive.

2. The method of claim 1, further comprising the step of:
making an evaluation to determine whether the loaded disk in the optical disk drive is run-out according to the amplitude level of the center error signal

3. The method of claim 1, further comprising the step of:
processing the center error signal with a bad-pass filter before the center error signal is used as the base for determining whether the loaded disk in the optical disk drive is run-out.

4. The method of claim 3, wherein the band-pass filter is a band-pass filter with at least two levels.

5. A method for detecting a run-out disc in an optical disk drive, comprising:
using a track number accessed by a pickup head of the optical disk drive per a unit time for detecting the run-out disc in the optical disk drive.

6. The method of claim 5 further comprising the step of:
determining the optical disk as run-out if the track number is larger than a specified value, and determining the optical disk as not run-out if the track number is not larger than the specified value.

7. The method of claim 6 further comprising the step of:
using the time for the motor to rotate an integral number of revolutions in the optical disk drive as the unit time.

8. The method of claim 7 further comprising the step of:
using a plurality of polar points disposed on the motor to calculate the time for the motor to rotate the integral number of revolutions.

9. The method of claim 8 further comprising the step of:
using a tracking error signal and a radio frequency ripple signal of the optical disk drive to mirror and produce a half-track signal for evaluating the track number scanned by the pickup head on the optical disk disk.

10. An apparatus for detecting a run-out disc in an optical disk drive, comprising:
a pre-amplifier, for receiving a signal outputted from a pickup head to produce a center error signal, a tracking error signal, and a radio frequency ripple signal;
an analog/digital converter, for converting the center error signal, the tracking error signal, and the radio frequency ripple signal from analog signals into digital signals; and
a digital signal processor, for selectively receiving the digitized center error signal, the digitized tracking error signal, and the digitized radio frequency ripple signal as a basis for detecting the run-out disc in the optical disk drive.

11. An apparatus for detecting a run-out disc in an optical disk drive, comprising:
a pre-amplifier, for receiving a signal outputted from a pickup head to produce a center error signal;
an analog/digital converter, for converting the center error signal from an analog signal into a digital-signal; and
a digital signal processor, for receiving the digitized center error signal as a basis for detecting the run-out disc in the optical disk drive.

12. An apparatus for detecting a run-out disc in an optical disk drive, comprising:
a pre-amplifier, for receiving a signal outputted from a pickup head to produce a tracking error signal and a radio frequency ripple signal,
an analog/digital converter, for converting the tracking error signal and the radio frequency ripple signal from analog signals into digital signals; and a digital signal processor, for receiving the digitized tracking error signal and the digitized radio frequency ripple signal as a basis for detecting the run-out disc in the optical disk drive.
